(19) United States
(12) Patent Application Publication
(10) Pub. No.: US 2024/0098356 A1
(43) Pub. Date: Mar. 21, 2024

(54) IMAGE CAPTURING APPARATUS, ANALYSIS METHOD, AND STORAGE MEDIUM

(71) Applicant: CANON KABUSHIKI KAISHA, Tokyo (JP)

(72) Inventor: YASUAKI ISE, Kanagawa (JP)

(21) Appl. No.: 18/466,509

(22) Filed: Sep. 13, 2023

(30) Foreign Application Priority Data
Sep. 15, 2022 (JP) 2022-147014

(51) Int. Cl. H04N 23/61; H04N 23/69; H04N 23/695

(52) U.S. Cl. CPC H04N 23/61; H04N 23/69; H04N 23/695

(57) ABSTRACT

A necessary analysis processing function is configured to be set for each preset in performing imaging by a preset patrol to make it possible to perform different analysis processing functions for different imaging ranges. Further, in a case where an analysis result is configured to trigger a change of a preset, changes of imaging ranges are reduced to only those that are necessary, and an imaging angle of view is changed to a setting that is suitable for a determination result of an analysis processing function, whereby accuracy of analysis processing improves.

### BACKGROUND OF THE DISCLOSURE

### Field of the Disclosure

The present disclosure relates to an image capturing apparatus, an analysis method, and a storage medium.

### Description of the Related Art

In recent years, systems that manage items in a store using image recognition are installed in stores. The systems, for example, perform image recognition to count the number of customers in the store and acquire attribute information about each customer having purchased an item. Further, the systems that manage items detect acquisition of an item from a shelf, detect purchase of the item, and process payment for the item, covering a wide variety of operations.

Japanese Patent Application Laid-Open No. 2010-113692 discusses a technique for analyzing actions of customers in a store and collecting information about the customers. This technique uses an entrance camera for capturing images of persons entering the store, an in-store camera for capturing images of persons moving within the store, and a cashier area camera for capturing images of persons paying for an item.

In order to realize a wide variety of functions as in the technique discussed in Japanese Patent Application Laid-Open No. 2010-113692, a plurality of cameras is installed. Further, since a suitable imaging range is set for each detection target, a camera is set at each imaging location and for each purpose of use. Thus, a great number of cameras are used.

The present disclosure is directed to making it possible to set a suitable imaging range and a suitable analysis processing function for each detection target using fewer cameras in a system that manages a plurality of imaging ranges.

### SUMMARY OF THE DISCLOSURE

According to an aspect of the present disclosure, an analysis method includes analyzing a captured image captured by an image capturing unit, storing, in a storage device, preset information including information about a transition destination of an imaging range of the image capturing unit, and controlling the imaging range of the image capturing unit based on the preset information stored in the storage device, wherein the preset information associates each of the plurality of imaging ranges with a detail of an analysis, and wherein the analysis of the detail corresponding to the controlled imaging range is performed.

Further features of the present disclosure will become apparent from the following description of exemplary embodiments with reference to the attached drawings.

### BRIEF DESCRIPTION OF THE DRAWINGS

FIGS. 1A and 1B are block diagrams illustrating an example of an internal configuration of an image capturing apparatus and a client apparatus.

FIG. 2 is a flowchart illustrating an example of a process of performing a preset patrol according to a first exemplary embodiment.

FIG. 3 is a diagram illustrating an example of preset information.

FIGS. 4A and 4B are diagrams illustrating analysis processing performed in a store.

FIG. 5 is a flowchart illustrating an example of a process of determining a method for setting an analysis processing function in changing a preset.

FIG. 6 is a diagram illustrating an example of a user interface (UI) displayed on a display unit.

FIG. 7 is a diagram illustrating an example of a setting screen in changing a patrol order and a patrol timing of preset patrols.

FIG. 8 is a flowchart illustrating an example of a process of changing a preset based on settings in FIG. 7.

FIGS. 9A to 9C are diagrams illustrating an example of preset patrol operations in a store.

FIG. 10 is a flowchart illustrating an example of a process of performing a preset patrol in FIG. 9A.

### DESCRIPTION OF THE EMBODIMENTS

Various exemplary embodiments will be described in detail below with reference to the attached drawings. It is to be noted that the exemplary embodiments described below are not intended to limit the present disclosure and that while a plurality of features according to the exemplary embodiments is described below, not all of the plurality of features are always essential to the present disclosure, and the plurality of features can be combined as desired.

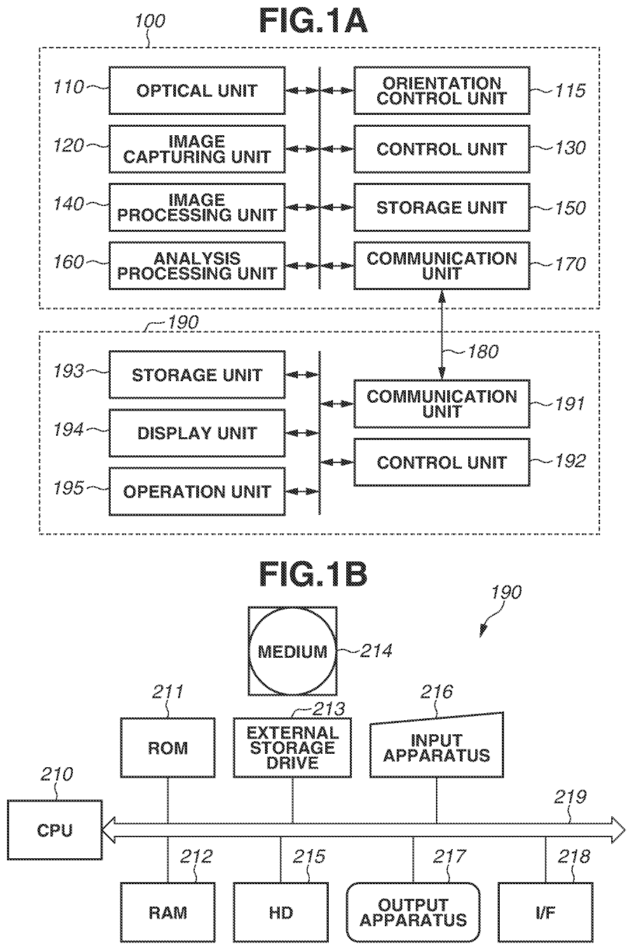

An image capturing apparatus according to a first exemplary embodiment will be described below with reference to FIG. 1A. FIG. 1A is a block diagram illustrating an example of an internal configuration of an image capturing apparatus 100 and a client apparatus 190 according to the present exemplary embodiment.

First, a configuration of the image capturing apparatus 100 will be described below. An image capturing unit 120 includes an image sensor for imaging an imaging region that is an imaging target. The image sensor is, for example, a complementary metal oxide semiconductor (CMOS) sensor that converts a subject image formed on an imaging surface into an electric signal and outputs the electric signal. An image signal that is the electric signal output from the image sensor is input to an image processing unit 140.

An optical unit 110 includes an optical function and guides light from the imaging region to the image sensor. An optical mechanism includes, for example, a control mechanism for controlling zoom, focus, aperture, and camera shake correction and a lens unit.

An orientation control unit 115 includes a drive mechanism that controls orientations of the image capturing unit 120 and is capable of changing an optical axis direction of the optical unit 110. According to the present exemplary embodiment, a two-axis drive mechanism capable of performing so-called pan/tilt drive (hereinafter, “PT drive”) will be described below as an example. The drive mechanism of the orientation control unit 115 includes a mechanical drive mechanism including a gear mechanism (not illustrated) and a drive source such as a direct current (DC) motor or a stepping motor. A drive amount, a drive direction, a drive velocity, a drive acceleration, and the like of the drive mechanism are controlled by a control unit 130. The orientation control unit 115 can be formed by connecting a camera platform separated from the image capturing apparatus 100. In this case, the camera platform and the image capturing apparatus 100 are removably joined via a mount and can be configured to exchange information via a communication unit 170 when joined together. Further, the drive mechanism that controls orientations is not limited to a two-axis PT drive, and a multi-joint manipulator can be used. Hereinafter, a combination of the PT drive by the orientation control unit 115 and the zoom operation by the optical unit 110 will be referred to as the PTZ (pan, tilt, zoom) drive.

The control unit 130 controls operations of the entire image capturing apparatus 100. Further, the control unit 130 compresses image data (still or moving image) and generates compressed image data. The control unit 130 compresses still images into, for example, Joint Photographic Experts Group (JPEG) compressed image data. Further, the control unit 130 compresses moving images into compressed image data in a format such as a Moving Picture Experts Group 4 (MPEG-4) (mp4) or Audio Video Interleaved (avi) format based on H.264, H.265, or Moving Picture Experts Group (MPEG) standards.

Further, the control unit 130 outputs uncompressed image data or compressed image data described above to a storage unit 150 or an external apparatus. Specifically, the control unit 130 stores (compressed) image data in the storage unit 150 or a removable recording medium (not illustrated) or transmits (compressed) image data to the client apparatus 190 via the communication unit 170 and a network 180.

The image processing unit 140 performs various types of image processing on image data captured by the image capturing unit 120. For example, the image processing unit 140 generates visible light images and non-visible light images by performing image processing such as pixel interpolation processing or color conversion processing on image signals acquired from the image sensor. Further, the image processing unit 140 can perform correction processing such as pixel defect correction or lens correction or detection processing for adjusting a black level, focus, or exposure.

The image processing unit 140 can further perform de-mosaicing processing, white balance processing, gamma correction processing, edge enhancement processing, or noise reduction processing. Then, the image processing unit 140 stores image data having undergone the foregoing image processing in the storage unit 150.

The storage unit 150 stores programs or data. The storage unit 150 includes a non-volatile memory and a random access memory (RAM). The non-volatile memory stores control programs defining processes to be performed by the control unit 130 and information such as various parameters and image data for use in processing by the control unit 130. The RAM is used as a work area for the control unit 130 and is also used as a storage area for the image processing unit 140 to perform image processing.

An analysis processing unit 160 analyzes image data (hereinafter, “captured image”) captured by the image capturing unit 120 and audio data acquired by a microphone (not illustrated). The analysis processing unit 160 selectively performs at least one of pre-analysis processing, analysis processing, and post-analysis processing, which will be described below, on the captured image. The pre-analysis processing is processing performed on the captured image before the analysis processing described below is performed. In the pre-analysis processing according to the present exemplary embodiment, for example, processing of dividing the captured image and generating divided images is performed.

The analysis processing is processing of analyzing an input image to obtain information and outputting the obtained information. In the analysis processing according to the present exemplary embodiment, for example, the divided images generated by the pre-analysis processing are input, and human body detection processing, face detection processing, and moving object detection processing are performed on the input images. Then, a result of the analysis processing is output. The analysis processing is, for example, processing configured to output positions of objects in the divided images using a machine learning model trained to detect objects within images.

The post-analysis processing is processing performed after the analysis processing is performed. In the post-analysis processing according to the present exemplary embodiment, for example, processing of outputting, as a processing result, a value obtained by totaling the numbers of objects detected in the divided images based on the result of the analysis processing on the divided images is performed.

It is to be noted that in the analysis processing, processing of performing pattern matching to detect objects in the images and outputting positions of the detected objects can be performed. Further, in the analysis processing, for example, face recognition processing of determining whether a person stored in advance is included in the images can be performed. In the face recognition processing, for example, a matching level of an image feature amount of the person stored in advance and an image feature amount of a person detected from an input image is calculated, and in a case where the matching level is higher than or equal to a threshold, the detected person is determined as the person stored in advance.

Furthermore, in the analysis processing, processing of superimposing a predetermined mask image or mosaic processing can be performed on the person detected from the input image in order to protect privacy. Further, action analysis processing of determining whether a person in the images is performing a specific action can be performed using a trained model trained to learn the specific action of the person by machine learning. Furthermore, processing of determining details of a region in the images can be performed. For example, processing of determining details of a region in the images can be performed using a trained model trained to learn buildings, roads, persons, and skies by machine learning. As described above, the analysis processing that can be performed is applicable to both the image analysis processing that uses machine learning and the image analysis processing that does not use machine learning.

The analysis processing unit 160 can include, for example, an application specific standard product (ASSP) and a field programmable gate array (FPGA) that are configured to be capable of performing inference processing using neural network (NN) models. Further, an NN model for each type of inference processing and parameters for performing inference processing can be stored in advance in the storage unit 150. In selecting analysis processing to be performed by the analysis processing unit 160, the NN model and the parameters for the inference processing are developed to an inference processing unit of the FPGA or the ASSP to change the analysis processing function to be performed.

The communication unit 170 is a network processing circuit including a communication interface (communication I/F). The communication unit 170, for example, converts (compressed) image data into communication signals based on communication protocols and transmits the communication signals to the network 180 via the communication I/F. The communication I/F can include a wireless communication module. The wireless communication module can include well-known circuits including an antenna system, a radio-frequency (RF) transmitter/receiver, one or more amplifiers, a resonant device, one or more oscillators, a digital signal processor, a codec chip set, a member identification module card, or a memory. Further, the communication I/F can include a wired communication module for wired connection.

The wired communication module enables communication with devices such as the client apparatus 190 via one or more external ports. The external ports establish a connection with another device directly or indirectly via a network based on standards such as “local area network”, “universal serial bus (USB)”, and “Institute of Electrical and Electronics Engineers (IEEE) 1394”. Furthermore, the communication I/F can include various software components that process data. It is to be noted that the communication I/F can also be realized using software configured to realize functions that are equivalent to those described above.

Each component of the image capturing apparatus 100 can be formed by dedicated hardware or can be realized by software. According to the exemplary embodiment described below, the control unit 130 and the image processing unit 140 are realized by software. For example, the functions of the control unit 130 and the image processing unit 140 are realized by a processor such as a central processing unit (CPU) executing programs stored in the storage unit 150. Further, the analysis processing unit 160 can be formed as an external device connected to the image capturing apparatus 100. For example, the analysis processing unit 160 can be formed as an inference processing device connected to the image capturing apparatus 100 via an interface (I/F) such as a USB I/F. In this case, the analysis processing unit 160 is configured to analyze audio data and image data transmitted from the control unit 130 to the analysis processing unit 160 and transmit analysis results to the control unit 130.

Next, an internal configuration of the client apparatus 190 will be described below. The client apparatus 190 is connected to the image capturing apparatus 100 via the network 180 and can communicate with the image capturing apparatus 100. The client apparatus 190 can be, for example, an information processing apparatus such as a personal computer (PC). The client apparatus 190 includes, for example, a communication unit 191, a control unit 192, a storage unit 193, a display unit 194, and an operation unit 195.

The communication unit 191 is a network processing circuit and communicates with the image capturing apparatus 100 via the network 180.

The control unit 192 receives (compressed) image data from the image capturing apparatus 100 and performs decompression processing on the (compressed) image data as needed. Further, the control unit 192 controls operations of the image capturing apparatus 100 by transmitting control information for controlling the image capturing apparatus 100 to the image capturing apparatus 100 via the communication unit 191.

The storage unit 193 stores image data received from the communication unit 191 or image data decompressed by the control unit 192.

The display unit 194 displays image data received via the communication unit 191, image data stored in the storage unit 193, and user interfaces (UIs) such as icons.

The operation unit 195 receives operations input by a user via a mouse or a keyboard. The user operates the mouse or the keyboard based on the UIs such as icons displayed on the display unit 194, and the operation unit 195 inputs the operation information.

It is to be noted that each component of the client apparatus 190 can be formed by dedicated hardware or can be realized by software. According to the exemplary embodiment described below, the control unit 192 is realized by software. For example, the functions of the control unit 192 are realized by a processor such as a CPU executing programs stored in the storage unit 193.

FIG. 1B is a block diagram illustrating an example of a hardware configuration of the client apparatus 190. A CPU 210 realizes processing corresponding to the present exemplary embodiment by executing an operating system (OS), control programs, or processing programs stored in a hard disk apparatus (HD) 215, which is part of the storage unit 193. Further, the CPU 210 controls data transmission and reception to and from external apparatuses via an I/F 218.

A read-only memory (ROM) 211 stores various types of data such as a basic input/output (basic I/O) program and an application program that executes predetermined processing. A (RAM) 212 temporarily stores various types of data and functions as a main memory or a work area for the CPU 210. An external storage drive 213 can access a medium (recording medium) 214 and can load, for example, a program stored in the medium 214. The HD 215 is a large capacity memory and is, for example, a hard disk. The HD 215 stores the application program, the OS, the control programs, or related programs. The system of the client apparatus 190 illustrated in FIG. 1B can include a non-volatile storage apparatus such as a flash memory instead of the HD 215. The ROM 211, the RAM 212, and the HD 215 function as the storage unit 193 illustrated in FIG. 1A.

An input apparatus 216 acquires input to the client apparatus 190 by the user. The input apparatus 216 can be, for example, a keyboard, a pointing device (such as a mouse), or a touch panel and corresponds to the operation unit 195 illustrated in FIG. 1A.

An output apparatus 217 outputs commands input via the input apparatus 216 and responses from the client apparatus 190 to the commands. The output apparatus 217 includes, for example, the display unit 194 illustrated in FIG. 1A and further includes a speaker or a headphone terminal.

The I/F 218 is an interface via which data is exchanged with external apparatuses such as the image capturing apparatus 100. For example, the I/F 218 can include a wireless communication module. The wireless communication module can include well-known circuits including an antenna system, an RF transmitter/receiver, one or more amplifiers, a resonant device, one or more oscillators, a digital signal processor, a codec chip set, a member identification module card, or a memory. Further, the I/F 218 can include a wired communication module for wired connection. The wired communication module enables communication with devices such as the image capturing apparatus 100 via one or more external ports. The external ports establish a connection with another device directly or indirectly via a network based on standards such as “local area network”, “USB”, or “IEEE 1394”. Furthermore, the I/F 218 can include various software components that process data. It is to be noted that the I/F 218 can also be realized using software configured to realize functions that are equivalent to those described above. The I/F 218 can function as the communication unit 191 illustrated in FIG. 1A.

A system bus 219 is a bus for transmitting and receiving data in the system illustrated in FIG. 1B.

Next, camera operations of the PTZ drive according to the present exemplary embodiment will be described below. Fixed-type cameras that fix an imaging range and perform imaging and PTZ-type cameras that use a pan/tilt function and perform imaging while changing an imaging range as needed or patrolling are widely known as cameras for use in monitoring systems. In the PTZ-type cameras, a suitable imaging angle of view is often pre-registered for each subject, and this pre-registration of an imaging angle of view is generally referred to as “preset”. Especially in operations for monitoring, a specific work region is patrolled and monitored to determine whether there is an abnormality, and only imaging directions and angles of view are preset and imaging control (preset patrol) is performed while the imaging directions are changed in order at every predetermined time. According to the present exemplary embodiment, a necessary analysis processing functions is configured to be set for each preset in performing imaging in a preset patrol, making it possible to perform different analysis processing functions for different imaging ranges.

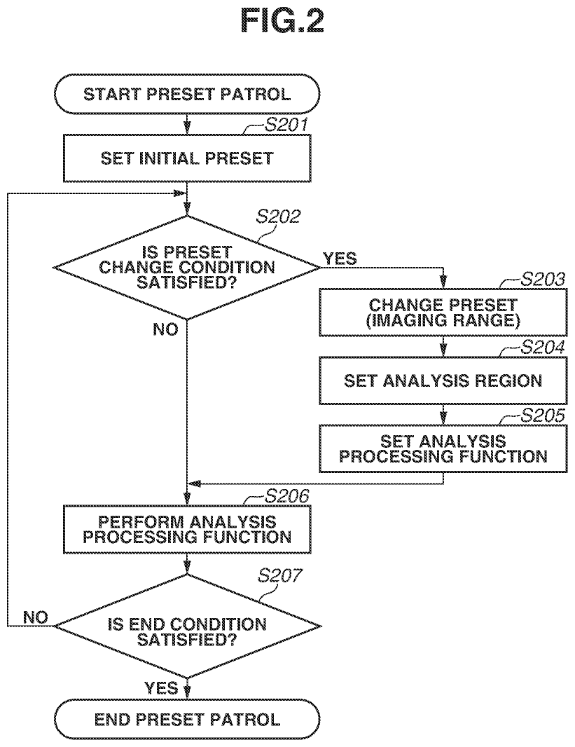

FIG. 2 is a flowchart illustrating an example of a preset patrol process by the image capturing apparatus 100 according to the present exemplary embodiment.

In step S201, the control unit 130 sets an initial preset. In this processing, first, the control unit 130 acquires imaging range information from the preset information stored in the storage unit 150. The preset information herein contains information indicating an imaging angle of view (pan position, tilt position, zoom position) and preset patrol information. The preset patrol information is information indicating an imaging time of each imaging range and an imaging range switch order (imaging order) in a case where a plurality of preset imaging ranges is to be patrolled and imaged. Details of the preset information will be described below.

Next, after acquiring the imaging range information from the preset information, the control unit 130 selects a designated zoom magnification for a zoom mechanism of the optical unit 110. Furthermore, the control unit 130 sets an imaging direction (PT drive) for the orientation control unit 115 and instructs the image capturing unit 120 to start imaging in an initially-set orientation. Then, the control unit 130 acquires analysis region information from the preset information, sets an analysis region, and controls the analysis processing unit 160 to start analysis processing on the set analysis region. The analysis processing is, for example, a function of imaging an entire store and counting the number of customers in the store.

Next, in step S202, the control unit 130 determines whether a preset change condition is satisfied. A case where the imaging time is set as the preset change condition will be described below as an example. The control unit 130 determines whether the imaging time from the previous preset setting has exceeded a predetermined length of time. In a case where the imaging time has exceeded the predetermined length of time, the control unit 130 determines that the preset change condition is satisfied. It is to be noted that the preset change condition can be a condition other than an elapse of the imaging time. As a result of the determination in step S202, in a case where the preset change condition is satisfied (YES in step S202), the processing proceeds to step S203. Otherwise (NO in step S202), the processing proceeds to step S206 to continue the current processing.

In step S203, the control unit 130 changes the preset imaging range. As in step S201, the control unit 130 acquires imaging range information from the preset information to be used next and sets a zoom magnification for the optical unit 110 and a PT drive for the orientation control unit 115, thereby changing the imaging range.

In step S204, the control unit 130 sets an analysis region in the changed imaging range.

In this processing, as in step S201, the control unit 130 acquires analysis region information from the preset information and sets an analysis region. It is to be noted that a plurality of analysis regions can be set for one preset.

In step S205, an analysis processing function is set. An analysis processing function is set for the analysis region set in step S204. In a case where a plurality of analysis regions is set for one preset, an analysis processing function is set for each set analysis region. In this case, different analysis processing functions can be set for different analysis regions.

In step S206, the analysis processing unit 160 performs the analysis processing function. The analysis processing unit 160 analyzes image data (captured image) captured by the image capturing unit 120 and stores an analysis result in the storage unit 150. For example, in a case where an analysis result request is issued by the user from the client apparatus 190, the control unit 130 transmits the analysis result to the client apparatus 190 via the communication unit 170. Then, the control unit 192 displays the analysis result on the display unit 194 of the client apparatus 190.

In step S207, the control unit 130 determines whether a preset patrol end condition is satisfied. The preset patrol end condition is, for example, a case where the preset change is performed a predetermined number of times or a case where a preset patrol stop instruction is issued by the user from the client apparatus 190. As a result of the determination in step S207, in a case where the preset patrol end condition is satisfied (YES in step S207), the process ends. Otherwise (NO in step S207), the processing returns to step S202 to continue the preset patrol.

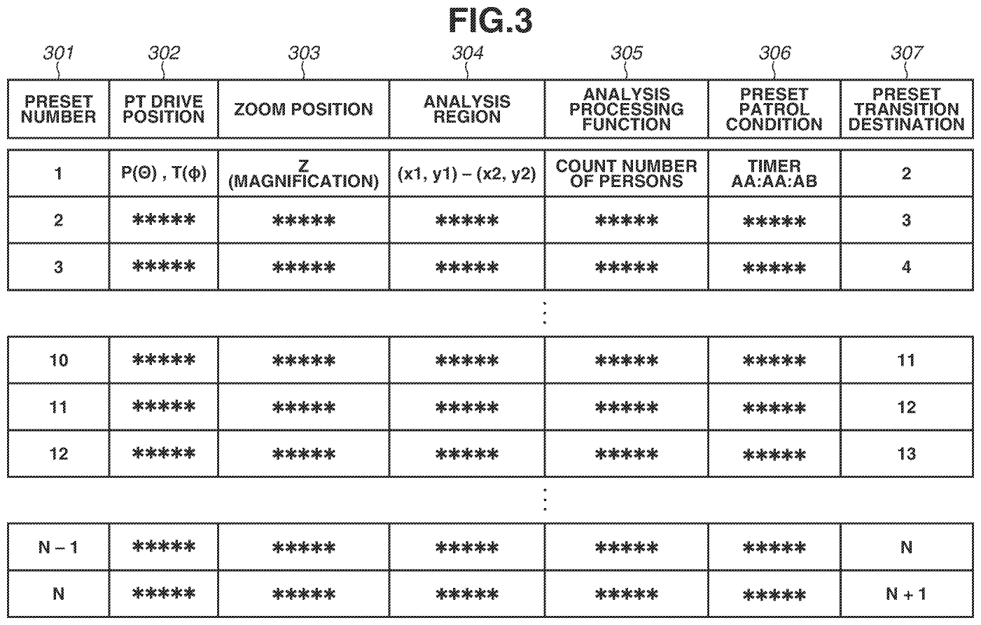

FIG. 3 is a diagram illustrating an example of preset information according to the present exemplary embodiment. The preset information is generated by, for example, the client apparatus 190 and is stored as a table in the storage unit 150. A preset number 301 is a number assigned to each preset, and the control unit 130 performs control based on setting values associated with the preset number 301. The setting values associated with the preset number 301 are a PT drive position 302, a zoom position 303, an analysis region 304, an analysis processing function 305, a preset patrol condition 306, and a preset transition destination 307. The setting values will be described below.

The PT drive position 302 is pan/tilt coordinate information specifying a movement position of the drive mechanism in performing the PT drive. The zoom position 303 is position information specifying a drive position of a zoom lens unit. The PT drive position and the zoom position are set so that an intended region will be imaged.

The analysis region 304 is information about an analysis processing target region in captured images, and an intended region can be preset as the analysis region 304. The analysis processing function 305 is information about details of an analysis processing function to be performed in the designated analysis region. For example, in a case where an entry detection function is set as the analysis processing function, whether a person has entered the analysis region is detected. Further, by setting an entire imaging range as an analysis region and setting number-of-persons count processing as an analysis processing function, a process of counting the current number of persons in the store can be performed in a case where the entire store is within the imaging range.

The preset patrol condition 306 is a condition for changing to a next preset. For example, in a case where an imaging time of each preset is set as the preset patrol condition 306, a drive is performed to move to a next preset in a case where a length of time set by a timer has passed. In step S202, the control unit 130 determines whether the condition specified by the preset patrol condition 306 is satisfied.

The preset transition destination 307 specifies a preset number to be referred to in performing a next preset. In the example in FIG. 3, the preset number is set to be incremented by “+1”. For example, in a case where a predetermined imaging time has passed in a state where a preset is set with a condition of a preset number 1, a preset number 2 is set as preset information to be used next. A transition destination can be set as desired, and a transition destination of a preset number can be configured to be changeable by a user operation from the client apparatus 190 while a preset patrol is being performed.

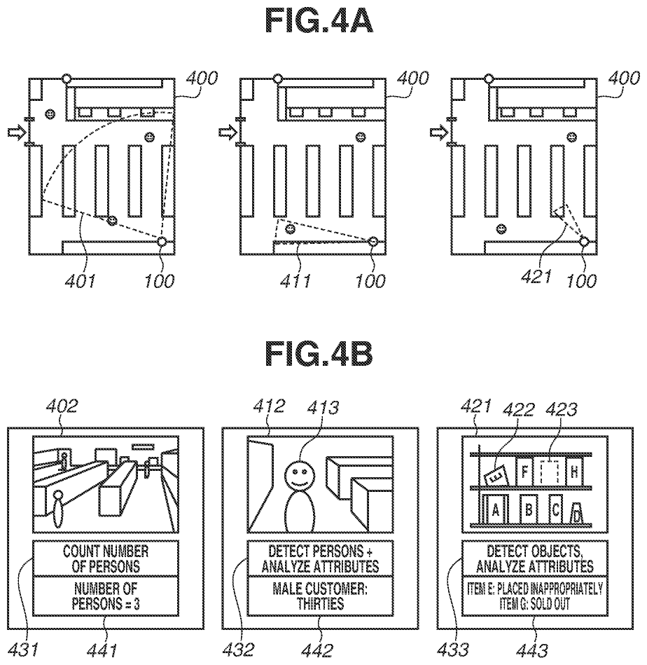

FIGS. 4A and 4B are diagrams illustrating analysis processing performed in a store 400. FIG. 4A illustrates a layout and imaging ranges in the store 400, and presets 401, 411, and 421 specify imaging ranges of the presets 401, 411, and 421 of the image capturing apparatus 100. FIG. 4B illustrates captured images captured by the image capturing apparatus 100, analysis processing functions 431 to 433, and analysis results 441 to 443 of analysis processing performed by the image capturing apparatus 100, which are displayed on the display unit 194 of the client apparatus 190.

For the preset 401, the angle of view is widened so that the imaging range covers the entire store, and imaging is performed. At this time, the number-of-persons count processing is selected as an analysis processing function for a captured image 402, and information indicating that the number of persons detected in the analysis region is three is displayed as an analysis result of the number-of-persons count processing.

For the preset 411, a partial region in the store is set as an imaging range, and imaging is performed. Further, “person detection processing” and “attribute analysis processing” are set as analysis processing functions. A person 413 is captured as a subject in a captured image 412. In this example, the person 413 in the captured image is recognized as an analysis result of the person detection processing by the image capturing apparatus 100. Furthermore, attribute information about the person 413 such as “male customer” and “thirties” are detected as an analysis result of the attribute analysis processing and are displayed on the display unit 194.

For the preset 421, another partial region in the store is set as an imaging range, and imaging is performed. Further, “object detection processing” and “attribute analysis processing” are set as analysis processing functions. In the captured image, an item 422 has fallen sideways, and an occurrence of inappropriate placement is detected as an analysis result of the attribute analysis processing. Further, since an item 423 is not present at a predetermined position, a state where the item 423 is sold out is detected as an analysis result of the object detection processing, and a warning notification is presented on the display unit 194.

As described above, by performing the preset patrol and the analysis processing using an image capturing apparatus capable of performing the PTZ drive, one image capturing apparatus can perform a plurality of functions. Further, by setting an analysis processing function as a preset patrol function for each preset, the plurality of analysis processing functions is performed easily without requiring the user to perform an operation of switching the processing actively. Setting an analysis processing function together with an imaging range as preset information as described above makes it possible to perform analysis processing with an angle-of-view setting that is suitable for the analysis processing.

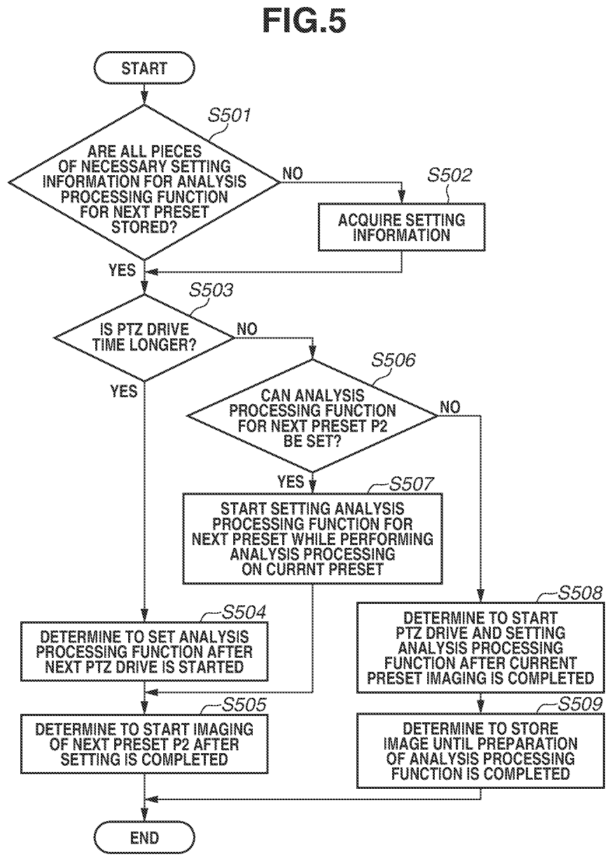

Next, a process of changing an analysis processing function during a preset patrol will be described below with reference to a flowchart in FIG. 5. In the example illustrated in FIG. 2, first an analysis region is set after the PTZ drive is performed, and thereafter an analysis processing function is set, in a case where a preset is changed. Some analysis processing functions necessitate a great amount of time to configure settings, and in this case, it is not possible to perform analysis processing for a while after the PTZ drive for changing to a next preset is completed. Thus, the analysis processing function setting may be started as early as possible, as in the process illustrated in FIG. 5. This process will be described specifically below.

FIG. 5 is a flowchart illustrating an example of a process of determining an analysis processing function setting method in changing a preset. Hereinafter, a preset that is currently performed will be referred to as “preset P1”, and a next preset will be referred to as “preset P2”. It is to be noted that the process illustrated in FIG. 5 is a process that is performed while the preset P1 is being performed and that the process is started at a desired timing.

In step S501, the control unit 130 determines whether all pieces of necessary setting information for the analysis processing function for the next preset P2 are stored. It is to be noted that necessary setting information for the analysis processing function can be stored in the storage unit 150 or in the analysis processing unit 160. As a result of the determination in step S501, in a case where not all pieces of necessary setting information are stored (NO in step S501), the processing proceeds to step S502, whereas in a case where all pieces of necessary setting information are stored (YES in step S501), the processing proceeds to step S503.

In step S502, the control unit 130 accesses the client apparatus 190 and an external server (not illustrated) via the communication unit 170 and acquires necessary setting information for the analysis processing function for the preset P2. Then, the control unit 130 stores the acquired setting information for the analysis processing function for the preset P2 in the storage unit 150. For example, in a case where inference processing using a NN model is included in the analysis processing function, necessary setting information is the NN model to be set for the analysis processing unit 160 and setting parameters of the NN model.

In step S503, the control unit 130 determines whether a PTZ drive time for changing to the next preset P2 is longer than a setting time of the analysis processing function for the next preset P2. As a result of the determination, in a case where the PTZ drive time is longer than the setting time of the analysis processing function (YES in step S503), the processing proceeds to step S504. Otherwise (NO in step S503), the processing proceeds to step S506.

In step S504, the control unit 130 determines to set the analysis processing function after the PTZ drive for changing to the next preset P2 is started after the condition for changing the current preset P1 is satisfied. Specifically, the setting is performed based on the process illustrated in FIG. 2 in preset changing. In the PTZ drive, since the drive mechanism is operated, movement velocities may be limited due to motor constraints. Further, the PTZ drive time increases with the movement amount of the PTZ drive. Thus, in a case where the analysis processing function setting time is shorter than the PTZ drive time, the analysis region setting and the analysis processing function setting are performed immediately after the PTZ drive is completed, as in the process illustrated in FIG. 2.

In step S505, the control unit 130 determines to start imaging of the preset P2 including the analysis processing after the setting of all necessary settings for the imaging of the preset P2 is completed.

In step S506, the control unit 130 refers to the preset information and determines whether the analysis processing function for the next preset P2 can be set during the imaging of the current preset P1. Some ASSP or FPGA configurations allow a plurality of analysis processing functions to be performed in parallel. In this case, the next analysis processing function can be set during performance of the current analysis processing. As a result of the determination in step S506, in a case where the analysis processing function for the next preset P2 can be set during the imaging of the current preset P1 (YES in step S506), the processing proceeds to step S507. Meanwhile, there are cases where an analysis processing function can be changed only after currently-performed analysis processing is stopped, due to constraints such as memory capacity. As a result of the determination in step S506, in a case where the analysis processing function for the next preset P2 cannot be set during the imaging of the current preset P1 (NO in step S506), the processing proceeds to step S508.

In step S507, the control unit 130 starts setting the analysis processing function for the next preset P2 while performing the analysis processing of the current preset P1. Thus, the PTZ drive associated with the next preset P2 is started after the imaging of the current preset P1 is completed, and the analysis processing function setting is completed before the PTZ drive is completed. This makes it possible to start imaging of the preset P2 including the analysis processing as soon as the PTZ drive is completed.

In step S508, the control unit 130 determines to start the PTZ drive and the analysis processing function setting in parallel after the imaging of the current preset P1 is completed.

In step S509, the control unit 130 determines to store, in the storage unit 150, the captured image of the period from when the PTZ drive is completed to when the preparation of the analysis processing function setting is completed. In this case, after the analysis processing function setting for the preset P2 is completed, the analysis processing unit 160 performs analysis processing on a current captured image acquired after the setting is completed. Furthermore, the analysis processing unit 160 performs analysis processing on the captured image stored in the storage unit 150 in parallel with the analysis processing on the current captured image. In a case where an analysis processing time of image data analyzed by the analysis processing unit 160 is sufficiently shorter than an imaging frame rate of the image sensor, the analysis processing on the captured image stored in the storage unit 150 can be performed between frames of the current captured image.

The PTZ drive time is short in a case where the movement amount of the PTZ drive is small or processing of changing only a display angle of view as in electronic zooming is performed. Further, the setting time of the analysis processing unit 160 is long in a case where the analysis processing unit 160 is configured to include a FPGA and an internal circuit is reconfigured or the volume of the setting parameters is large. In a case where the analysis processing function setting time is relatively long as described above, when the analysis processing function setting is incomplete, the captured image is temporarily stored in the storage unit 150, and the analysis processing is performed on the captured image afterward. This makes it possible to perform the subject analysis also during the period from when the PTZ drive is completed to when the analysis function setting is completed.

By preforming the process illustrated in FIG. 5 as described above, the time from the setting of the preset to the start of the analysis is reduced. Since the time during which no analysis processing is performed on the captured image in the preset patrol is reduced, the possibility of missing a necessary subject is also reduced.

A preset patrol according to a second exemplary embodiment will be described below. In the above-described example according to the first exemplary embodiment, the preset is changed based on the imaging time. In a below-described example according to the present exemplary embodiment, a preset is changed based on an analysis result of analysis processing. First, a setting method in a case where the user changes a preset based on an analysis result of an analysis processing function will be described below. It is to be noted that configurations of the image capturing apparatus 100 and the client apparatus 190 according to the present exemplary embodiment are similar to those illustrated in FIG. 1 and redundant descriptions thereof are omitted.

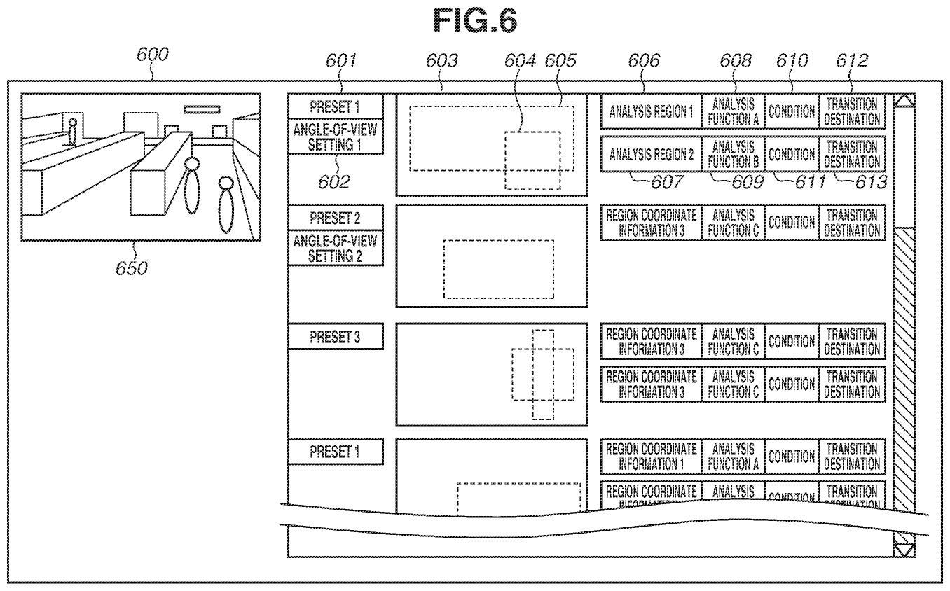

FIG. 6 is a diagram illustrating an example of a UI that is displayed on the display unit 194. The image capturing apparatus 100 performs imaging and analysis processing, and a captured image and an analysis result are transmitted to the client apparatus 190. Then, the user performs an operation using the mouse while checking a UI screen 600 displayed on the display unit 194.

As illustrated in FIG. 6, a current captured image 650 is displayed at the left side of the UI screen 600. Further, a captured image 603 for each preset is displayed to the right side of the UI screen 600, and a preset number 601 and angle-of-view setting information 602 are added to the captured image 603. It is to be noted that the angle-of-view setting information 602 for each preset can be configured to specify PT drive position information and zoom magnification information and can include an icon such as a slide bar and coordinate information can be displayed as the angle-of-view setting information 602.

Further, analysis regions 604 and 605 are specified in the captured image 603 for each preset, and names 606 and 607 of the analysis regions 604 and 605 are added. It is to be noted that the user can be allowed to change an analysis region by performing drag-and-drop operations by operating the operation unit 195 and a plurality of different analysis regions can be configured to be settable in a captured image. Further, analysis processing functions 608 and 609 and determination conditions 610 and 611 of the analysis processing functions 608 and 609 for changing the preset 1 are displayed to the right side of the names 606 and 607 of the analysis regions 604 and 605. Furthermore, transition destination presets 612 and 613 are also displayed. It is to be noted that each item displayed on the UI screen 600 in FIG. 6 can be configured to be selectable with ease using a pull-tab.

As described above, the UI screen 600 illustrated in FIG. 6 is displayed on the display unit 194 so that the user can easily recognize the settings of the analysis processing functions for each preset. This enables the user to easily determine a necessary analysis processing function while viewing a captured image for each preset and also enables the user to perform an operation of changing a necessary function or a patrol destination with ease.

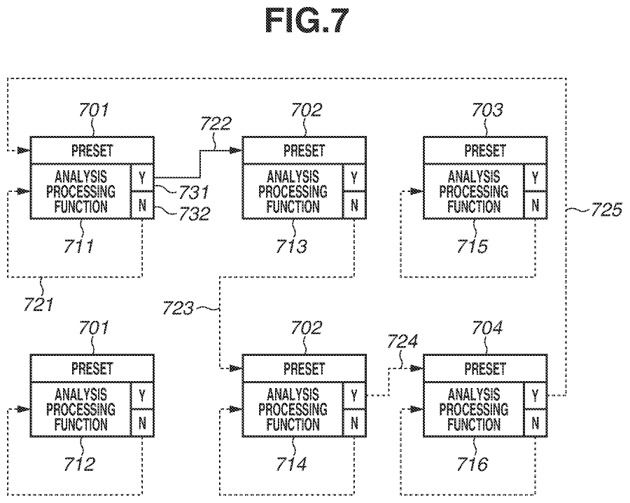

FIG. 7 is a diagram illustrating an example of a setting screen in configuring a setting to change a preset based on an analysis result of an analysis processing function. In the setting screen in FIG. 7, arrows 721 to 725 are UI displays each connecting an analysis result of an analysis processing function and a preset transition destination. Determination conditions 731 and 732 indicate options of determination conditions of an analysis processing function 711, and a determination condition Y indicates “YES” whereas a determination condition N indicates “NO”.

The user can connect a determination condition Y or a determination condition N and a preset number of a transition destination with an arrow by performing drag-and-drop operations by operating the operation unit 195, thereby setting an intended preset change condition and an intended transition destination. It is to be noted that the analysis processing functions 711 and 712 set for the same preset 701 can be applied simultaneously at the time when the preset 701 is selected, as illustrated in FIG. 7.

The example in FIG. 7 will be described in detail below. For example, the arrow 721 connects the determination condition N of the analysis processing function 711 to the same analysis processing function 711, and the arrow 722 connects the determination result Y of the analysis processing function 711 to a preset 702. This indicates that the analysis processing function 711 is continued until the determination result Y of the analysis processing function 711 is detected and the preset 701 changes to the preset 702 in a case where the determination result Y is detected. For example, in a case where the analysis processing function 711 is an object detection function of detecting a specific item A and the item A is detected in an analysis region in a captured image by object detection processing, i.e., the determination result is “YES”, the preset 701 changes to the preset 702 connected with the determination condition Y 731 by the arrow 722.

Further, no arrows from other analysis processing functions are connected to the analysis processing function 712. Thus, the analysis processing function 712 is performed simultaneously with the analysis processing function 711 at the time when the preset 701 is selected. Further, the analysis processing function 713 is connected to an analysis processing function 714 by the arrow 723. Thus, after a determination result N of the analysis processing function 713 is detected, the analysis processing function 714 is sequentially performed. In the example illustrated in FIG. 7, the arrows 721 to 725 are connected so that with the preset 701 being a start point, the presets 701, 702, 704, and 701 are changed in this order each time a determination condition of an analysis processing function is satisfied. In a case where a preset change condition and a transition condition are changed on the above-described setting screen by the user, the control unit 192 transmits information about the change to the image capturing apparatus 100. Then, the control unit 130 of the image capturing apparatus 100 having received the information about the change updates the preset information stored in the storage unit 150.

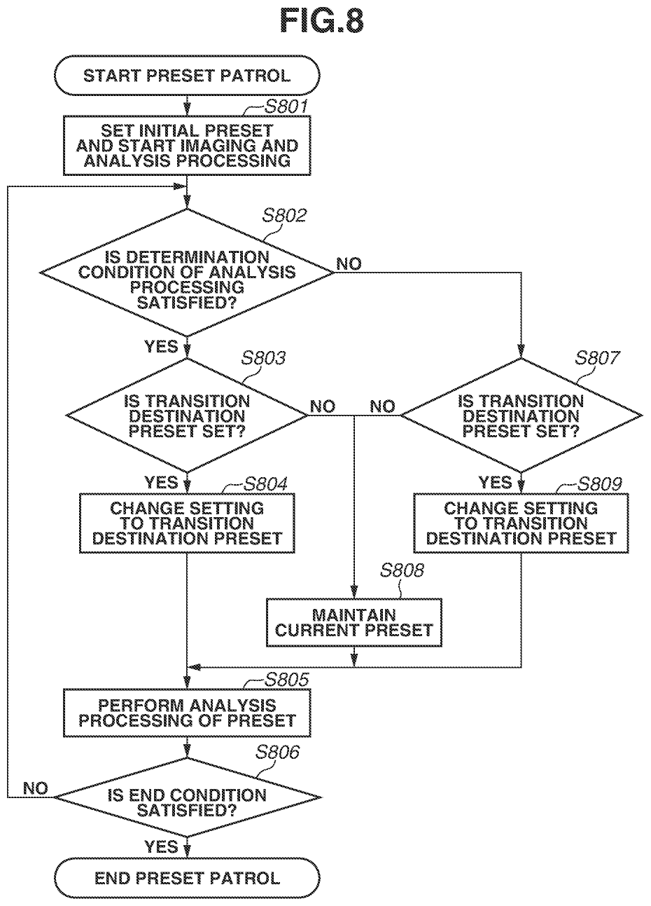

FIG. 8 is a flowchart illustrating a process of changing a preset based on the settings in FIG. 7.

In step S801, the control unit 130 sets an initial preset and starts imaging and the analysis processing. It is to be noted that this processing is basically the same as step S201 in FIG. 2.

Next, in step S802, the control unit 130 determines whether a determination condition of the currently-performed analysis processing is satisfied. A captured image captured by the image capturing unit 120 is processed by the image processing unit 140, and then the processed image is output to the analysis processing unit 160 and undergoes the analysis processing. For example, in a case where the analysis processing function is the entry detection processing of detecting an entry into a specific region, the determination result is “YES” in a case where an entry into the region is detected, whereas the determination result is always “NO” in a state where no entry is detected. Further, in a case where the analysis processing function is the object detection function of detecting the specific item A, the determination result is “YES” in a case where the item A is displayed, whereas the determination result is “NO” in a case where nothing is displayed or in a state where a different item B is captured. As a result of the determination in step S802, in a case where the determination condition is satisfied (in a case where the determination result is “YES”) (YES in step S802), the processing proceeds to step S803. Otherwise (in a case where the determination result is “NO”) (NO in step S802), the processing proceeds to step S807.

In step S803, the control unit 130 determines whether a transition destination preset is set for a case where the determination result is “YES”. For example, a transition destination preset is set for a case where the determination result of the analysis processing function 711 of the preset 701 is “YES”, whereas no transition destination preset is set for a case where the determination result of the analysis processing function 713 of the preset 702 is “YES”. As a result of the determination in step S803, in a case where a transition destination preset is set (YES in step S803), the processing proceeds to step S804. Otherwise (NO in step S803), the processing proceeds to step S808.

In step S804, the control unit 130 changes the settings for the image capturing apparatus 100 to the transition destination preset that is set for a case where the determination result is “YES”. Specifically, the PTZ drive setting, the analysis region setting, and the analysis processing function setting are set.

In step S805, the control unit 130 performs the analysis processing of the current preset.

In step S806, the control unit 130 determines whether the preset patrol end condition is satisfied. The preset patrol end condition is basically the same as that in step S207 in FIG. 2. As a result of the determination in step S806, in a case where the preset patrol end condition is satisfied (YES in step S806), the process ends. Otherwise (NO in step S806), the processing returns to step S802.

On the other hand, in step S807, the control unit 130 determines whether a transition destination preset is set for a case where the determination result is “NO”. For example, a transition destination preset is set for a case where the determination result of the analysis processing function 713 of the preset 702 is “NO”, whereas no transition destination preset is set for a case where the determination result of the analysis processing function 711 of the preset 701 is “NO”. It is to be noted that the arrow 721 indicates that the determination of the analysis processing function 711 is to be repeated, and the preset 701 is maintained. As a result of the determination in step S807, in a case where a transition destination preset is set (YES in step S807), the processing proceeds to step S809. Otherwise (NO in step S807), the processing proceeds to step S808.

In step S808, the control unit 130 determines to maintain the current preset.

In step S809, the control unit 130 changes the setting for the image capturing apparatus 100 to the transition destination preset that is set for a case where the determination result is “NO”.

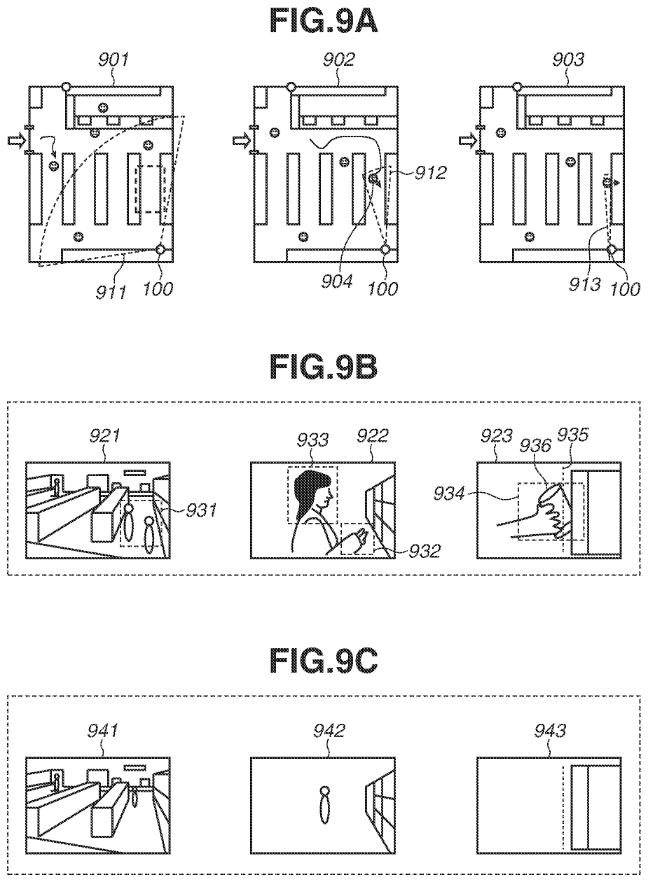

Next, a specific example of performing a preset patrol based on a determination result of analysis processing according to the present exemplary embodiment will be described below. FIGS. 9A to 9C are diagrams illustrating an example of preset patrol operations in a store. Layouts 901 to 903 in FIG. 9A indicate layouts in the store. Captured images 921 to 923 in FIG. 9B are captured images corresponding to presets (imaging ranges) 911 to 913, respectively. A system for cashier-less payment by detecting a situation where a customer has approached a shelf and picked up an item and then associating the customer with the item being picked up will be described below as an example with reference to FIGS. 9A to 9C.

The captured image 921 is an example of an image captured by wide-angle imaging of an area in the store based on the preset 911. The preset 911 is intended to detect the number of customers having entered the store and to analyze movements of the customers. Furthermore, “entry detection” is set as an analysis processing function for an analysis region 931. Each detected person is numbered and stored with the number in the storage unit 150 of the image capturing apparatus 100. In a case where an entry of a person into the analysis region 931, i.e., approach of a customer to a shelf, is detected, the preset 911 changes to the next preset 912.

The captured image 922 is a close-up image of the analysis region 931 captured at an angle of view for close-up imaging. Further, an action analysis function of analyzing an action of a person is set as an analysis processing function for an analysis region 932, and an attribute analysis function of analyzing an attribute of a person is set as an analysis processing function for an analysis region 933. In order to detect facial expressions and attribute information about persons, higher resolutions of subjects are desirable. In general, subjects with higher resolutions are often higher in detection accuracy than subjects with lower resolutions.

In the examples illustrated in FIGS. 9A to 9C, an item in which a customer 904 having approached a shelf is interested and details of the customer 904 are determined. For example, “female” and “twenties” are detected as an analysis result of analyzing the analysis region 933 from a person analysis result. The detected attribute information is stored in association with numbering information about the customer 904 stored in the storage unit 150. The attribute information about the customer 904 can also be utilized as marketing information for the item. Further, an action of “stretching a hand” toward the shelf by the customer 904 is detected as an analysis result of analyzing the analysis region 932 for the preset 912. Based on the foregoing result, the preset 912 changes to the preset 913, which is up-close to the shelf.

The captured image 923 is a close-up image of the analysis region 932 captured at an angle of view for close-up imaging and is a captured image of the shelf captured from the side. An analysis region 934 undergoes the detection of a hold of an item in a hand of the customer 904 and the item attribute analysis of analyzing an item 936 held in the hand. In a case where the item 936 being held in the hand of the customer 904 passes through a determination region 935, it is determined that the detected item 936 has been purchased by the customer 904, and this information is further stored in the storage unit 150.

FIG. 9C illustrates an example of captured images that are captured in a case where the presets 911 to 913 are switched at regular intervals without using a determination result of an analysis processing function. Captured images 941 to 943 are captured images corresponding to the presets 911 to 913, respectively. In a case where the presets 911 to 913 are switched based on the imaging time, the preset patrol is performed even in a state where there no target subject is being captured, as in the captured images 942 and 943. Thus, there is a possibility that the target subject cannot be captured. According to the present exemplary embodiment, the preset patrol is performed based on determination results of analysis processing functions as in the captured images 921 to 923 to reduce the possibility of missing an opportunity to analyze an action of a subject.

As described above, the setting is changed to an imaging angle of view that is suitable for a determination result of an analysis processing function by the PTZ drive, and this makes it possible to improve accuracy of analysis processing. Further, an analysis processing function is set together with an imaging range as preset information, and this makes it possible to perform analysis processing with an angle-of-view setting that is suitable for the analysis processing. According to the present exemplary embodiment, an analysis result triggers a transition of a preset, and this reduces changes of imaging ranges to only those that are necessary.

This reduces the number of times the analysis processing functions are switched, reduces cases where the imaging of shelves without a customer is continued, and makes it possible to continue the subject analysis.

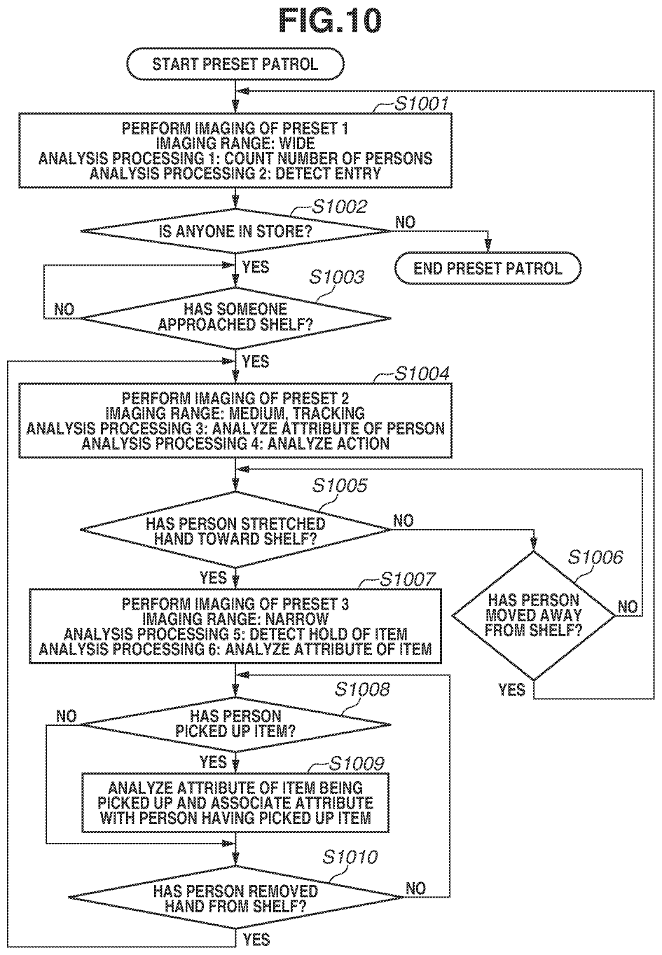

FIG. 10 is a flowchart illustrating an example of a process of performing the preset patrol illustrated in FIG. 9A. It is to be noted that the settings of the preset transition destination and the like are made by user operations on the screens illustrated in FIGS. 6 and 7, and this information is transmitted to the image capturing apparatus 100 to update the preset information. As described below, the control unit 130 performs imaging processing, PTZ drive, and captured image analysis processing based on the preset information stored in the storage unit 150, whereby the preset patrol is performed.

In step S1001, the control unit 130 sets a first preset with the entire space in the store being an imaging range. For the first preset, the entire imaging range is set as an analysis region. Further, a number-of-persons count function is set as a first analysis processing function, and the entry detection function is set as a second analysis processing function. Then, in a case where the analysis processing function setting is completed, the analysis processing unit 160 performs analysis processing.

In step S1002, the analysis processing unit 160 determines whether anyone is in the analysis region using the number-of-persons count function. As a result of the determination, in a case where someone is detected in the analysis region (YES in step S1002), the processing proceeds to step S1003. On the other hand, in a case where no one is detected in the analysis region (NO in step S1002), the preset patrol is ended. While the preset patrol is ended in the example illustrated in FIG. 10, it is also possible to wait until a new person is detected.

In step S1003, the analysis processing unit 160 waits until someone approaches a shelf based on the entry detection function. This determination of whether someone has approached a shelf can be performed by detecting whether someone detected by the number-of-persons count function has entered the specific region. Then, in a case where it is determined that someone has approached a shelf (YES in step S1003), the processing proceeds to step S1004.

In step S1004, the control unit 130 sets a second preset with an area in the vicinity of the shelf being an imaging range. For the second preset, after the imaging range is changed by the PTZ drive, an analysis region is set for each set analysis processing function, such as the analysis regions 932 and 933 in FIG. 9B. Then, the person attribute analysis function is set as a third analysis processing function, and the action analysis function is set as a fourth analysis processing function. Then, after the analysis processing function setting is completed, the analysis processing unit 160 performs new analysis processing.

In step S1005, the analysis processing unit 160 determines whether the detected person has stretched a hand of the detected person toward the shelf based on the action analysis function. For example, the action analysis function can detect an action of stretching an arm by detecting a human joint model. Furthermore, whether a distal end of the arm has approached the shelf can be determined by checking the distance between the distal end of the arm and the shelf to determine whether “the customer has stretched the hand of the customer”. It is to be noted that specific methods for the analysis processing are not particularly limited, and a similar advantage is also produced by detecting the shape of the “hand” directly using inference processing such as object detection. As a result of the determination in step S1005, in a case where the analysis processing unit 160 determines that the detected person has stretched the hand toward the shelf (YES in step S1005), the processing proceeds to step S1007. Otherwise (NO in step S1005), the processing proceeds to step S1006.

In step S1006, the analysis processing unit 160 determines whether the detected person has moved away from the shelf. In this processing, whether the person has moved away from the shelf is determined by, for example, determining whether the person is no longer detected from the analysis region. As a result of the determination in step S1006, in a case where the detected person has moved away from the shelf (YES in step S1006), the processing proceeds to step S1001, and the first preset for imaging the entire space in the store is set again. On the other hand, as a result of the determination in step S1006, in a case where the detected person has not moved away from the shelf (NO in step S1006), the processing proceeds to step S1005, and the analysis processing is continued.

In step S1007, the control unit 130 sets a third preset with a narrower imaging range. For the third preset, in order to detect the item that the person has acquired from the shelf, an imaging range that is further zoomed in to the shelf compared to the second preset is set. Then, after the imaging range is changed by the PTZ drive, a region in the vicinity of the hand is set as an analysis region. Further, a hold-of-item detection function is set as a fifth analysis processing function, and an item attribute analysis function is set as a sixth analysis processing function. Then, after the analysis processing function setting is completed, the analysis processing unit 160 performs new analysis processing.

In step S1008, the analysis processing unit 160 determines whether the detected person has picked up an item, based on the hold-of-item detection function. As a result of the determination, in a case where the detected person has picked up an item (YES in step S1008), the processing proceeds to step S1009. Otherwise (NO in step S1008), the processing proceeds to step S1010.

In step S1009, the analysis processing unit 160 analyzes attributes of the item being picked up based on the item attribute analysis function, associates the attributes with the person having picked up the item, and stores the foregoing information as information indicating that the person has acquired the item in the storage unit 150.

In step S1010, the analysis processing unit 160 determines whether the detected person has removed the hand from the shelf. As a result of the determination in step S1010, in a case where the detected person has removed the hand from the shelf (YES in step S1010), the processing proceeds to step S1004, and the second preset is set again. On the other hand, as a result of the determination in step S1010, in a case where the detected person has not removed the hand from the shelf (NO in step S1010), the processing proceeds to step S1008, and the analysis processing is continued.

As described above, according to the present exemplary embodiment, an analysis processing function is set together with an imaging range as preset information, and this makes it possible to perform analysis processing at a timing and an angle-of-view setting that are suitable for the analysis processing.

Further, the present exemplary embodiment makes it possible to set a suitable imaging range and a suitable analysis processing function for each detection target using fewer cameras in a system that manages a plurality of imaging ranges.

### Other Exemplary Embodiments

According to the second exemplary embodiment described above, the condition for changing the third preset to the second preset is the removal of the hand from the shelf in, for example, the example illustrated in FIG. 10. Meanwhile, the time of the first preset in FIG. 10 is relatively long during a period when only a few customers are present. Thus, for example, the imaging time can be used as the preset change condition as in the first exemplary embodiment during the time when very few customers are likely to be present. While the condition for changing the first preset to the second preset in the example in FIG. 10 is the approach of a person to the shelf, the first preset is changed to a preset with a specific shelf being an imaging range also in a case where a predetermined length of time has passed since the setting of the first preset. In this case, the preset 401 is changed to the preset 421, as in the examples illustrated in FIGS. 4A and 4B. This makes it possible to detect inappropriate placements on the shelves before closing the store during, for example, a period just before a closing time.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-147014, filed Sep. 15, 2022, which is hereby incorporated by reference herein in its entirety.

What is claimed is:

1. An image capturing apparatus comprising:
an image capturing unit;
one or more processors; and
one or more memories that store a computer-readable instruction configured to be executed by the one or more processors, thereby the computer-readable instruction causing the image capturing apparatus to:
analyze a captured image captured by the image capturing unit;
store, in a storage device, preset information including information about a transition destination of an imaging range of the image capturing unit; and
control the imaging range of the image capturing unit based on the preset information stored in the storage device,
wherein the preset information associates each of the plurality of imaging ranges with a detail of an analysis, and
wherein the analysis of the detail corresponding to the controlled imaging range is performed.

2. The image capturing apparatus according to claim 1, wherein the preset information further associates each imaging range with information about a condition for changing the imaging range.

3. The image capturing apparatus according to claim 2, wherein the condition for changing the imaging range is that an imaging time of the controlled imaging range exceeds a predetermined length of time.

4. The image capturing apparatus according to claim 2, wherein the condition for changing the imaging range is that a result of the analysis is a predetermined result.

5. The image capturing apparatus according to claim 2, wherein the condition for changing the imaging range is that an imaging time of the controlled imaging range exceeds a predetermined time or a result of the analysis is a predetermined result.

6. The image capturing apparatus according to claim 2, wherein the preset information is configured to update the information about the transition destination of the imaging range and the information about the condition for changing the imaging range.

7. The image capturing apparatus according to claim 6, wherein the preset information is updated based on an instruction from an external apparatus.

8. The image capturing apparatus according to claim 1, wherein the one or more processors start configuring a setting relating to analysis processing corresponding to the transition destination of the imaging range of the image capturing unit before the imaging range is changed by the control.

9. The image capturing apparatus according to claim 1, wherein the preset information is associated with information about an analysis region that is a target of the analysis.

10. The image capturing apparatus according to claim 1,
wherein the storage device stores the captured image of a period from when the control of the imaging range is completed to when the analysis is started, and
wherein the one or more processors analyze the captured image generated by the image capturing unit and analyze the captured image stored in the storage device.

11. An analysis method comprising:
analyzing a captured image captured by an image capturing unit;
storing, in a storage device, preset information including information about a transition destination of an imaging range of the image capturing unit; and
controlling the imaging range of the image capturing unit based on the preset information stored in the storage device,
wherein the preset information associates each of the plurality of imaging ranges with a detail of an analysis, and
wherein the analysis of the detail corresponding to the controlled imaging range is performed.

12. A non-transitory computer-readable storage medium that stores a program for causing a computer to:
analyze a captured image captured by an image capturing unit;
store, in a storage device, preset information including information about a transition destination of an imaging range of the image capturing unit; and
control the imaging range of the image capturing unit based on the preset information stored in the storage device,
wherein the preset information associates each of the plurality of imaging ranges with a detail of an analysis, and
wherein the analysis of the detail corresponding to the controlled imaging range is performed.
